(19) United States
(12) Patent Application Publication
(10) Pub. No.: US 2022/0001488 A1
(43) Pub. Date: Jan. 6, 2022

(54) DUAL WAVELENGTH LASER SOURCE FOR MATERIAL PROCESSING APPLICATIONS

(71) Applicant: II-VI Delaware, Inc., Wilmington, DE (US)

(72) Inventor: Haro Fritsche, Berlin (DE)

(73) Assignee: II-VI Delaware, Inc., Wilmington, DE (US)

(21) Appl. No.: 16/918,037

(22) Filed: Jul. 1, 2020

(51) Int. Cl. B23K 26/06; B23K 26/38

(52) U.S. Cl. CPC B23K 26/0604; B23K 26/0652; B23K 26/38; B23K 26/0648

(57) ABSTRACT

A high power, dual wavelength laser source is formed of a plurality of conventional IR laser diodes disposed in an aligned configuration such that the output beams from the plurality of laser diodes may be simultaneously passed through a bulk optic frequency multiplying device (e.g., a second-harmonic or third-harmonic generating crystal). The combination of the individual laser diodes creates a high power input beam, where the power level itself is determined by the number of individual devices (or bars) used at the input. The frequency multiplying device creates a known harmonic of the input beam, providing as an output two beams, one operating at the original wavelength (denoted λ) and another operating at a fraction of that original wavelength.

### TECHNICAL FIELD

The present invention relates to a laser-based tool for material processing applications and, more particularly, to a high power laser-based tool that emits two separate beams, each operating in different wavelength range that is selected for performing a specific process on a specific material (e.g., IR wavelength range and visible wavelength range).

### BACKGROUND OF THE INVENTION

Beyond their applicability as a communication medium, laser beams may be used for industrial processing of various types of materials (“industrial processing” including operations such as cutting, drilling, welding, brazing, surface annealing, alloying, and the like). An optical fiber is frequently used to deliver a high-power and/or high-intensity laser beam to a target material(s). Laser-based material processing has many advantages over traditional manufacturing techniques, among them including high productivity, improved quality, and high precision and mobility of the laser beam delivery point.

A laser-based material processing system typically includes a laser source, a process head, and an optical fiber cable (referred to frequently as the “delivery fiber”) coupled between the laser source and the process head. The process head is an optical assembly that includes a receptable for coupling to the delivery fiber and the optical components (e.g., lenses) necessary for projecting the laser power toward the material being “worked”. That is, the process head projects the laser beam onto a workpiece target area to perform the required processing task. The process head optical components provide the desired focal spot size, divergence, and beam quality at the workpiece, which may vary widely depending on, for example, the specific task (e.g., welding vs. cutting), the type of material being processed and its physical properties, etc. Since the process head is typically an imaging device, the spot near the workpiece is typically an image of the spot or, more specifically, the beam waist at the delivery fiber output, scaled by the magnification of the process head. The product of beam-waist radius and divergence (half-angle) is defined as the beam-parameter product (BPP) and is expressed in units of millimeter-milliradians (mm-mrads). FIG. 1 is a diagram illustrating the BPP, illustrating its invariant property for a given beam geometry. Referring to FIG. 1, a first value for BPP is provided by the multiplicative product of a first radius value r (measured in millimeters) and its half-angle divergence at angle of β (measured in milliradians). A second value for the BPP of this beam is defined by the product of larger beam waist value R and its associated half-angle α (where, as shown, α<β). In accordance with the invariant nature of the BPP, rβ=Rα.

Laser cutting and welding of materials such as copper, silver, gold and other so-called “highly reflective” materials is known to be difficult with conventional industrial laser sources that typically operate at a wavelength on the order of about 1 μm or so (for example, in the range from about 850-1060μμ). These highly reflective materials are known to have a very low absorption efficiency in this operating wavelength range, typically on the order of about 5% or so. FIG. 2 is a plot of absorption efficiency as a function of wavelength for various materials, showing this low efficiency at wavelengths around 1 μm. As also shown in FIG. 2, these materials (e.g., Ag, Au, and Cu) have a much higher absorption efficiency in the visible light spectrum. Thus, there have been attempts to design a laser source that operates in the blue-green wavelength range to allow efficient working of these highly reflective materials.

One prior art approach for creating high power visible laser sources is based on the use of frequency-doubled solid state lasers, such as Q-switched Nd:YAG lasers. While able to produce an output at a wavelength on the order of 532 nm (visible “green” light), the wall plug efficiency of this device is relatively low and the source itself is large in size. There is also a limit on the distance this visible light can propagate along a conventional type of delivery fiber before its power level drops below a usable threshold value.

Another approach is based upon the direct fabrication of “blue” laser diodes (i.e., laser diodes operating at a wavelength in the range of about 450-485 nm. At this point in time, these devices are expensive to manufacture, require hermetic packaging, are sensitive to oxygen, and are very susceptible to several different failure modes. For example, most embodiments use an array of blue laser diodes to generate sufficient power for cutting or welding. The failure of an individual laser diode causes the temperature of the entire array to elevate, where one or more laser diodes in the array may then fail, ultimately resulting in the complete failure of the array itself (i.e., an “avalanche” effect). Again, the distance that the blue light wavelength is able to propagate along a conventional delivery fiber before dropping below a useful power level is limited, as with the Q-switched Nd:YAG lasers.

In light of these difficulties associated with providing a blue laser source suitable for working highly reflective material, a need remains for a laser source that operates in the visible light region and has sufficient power to be used as a cutting/welding tool, while also exhibiting an efficiency more on the order of conventional laser tools.

### SUMMARY OF THE INVENTION

The needs remaining in the prior art are addressed by the present invention, which relates to a laser source suitable for use as a tool for cutting/welding highly reflective materials and, more particularly, to a dual wavelength laser source that emits both a visible (e.g., blue-green) beam preferred for initiating processes with these materials and an IR beam better-suited for finished processing. The inventive laser source, in its most general form, is contemplated as providing two separate output beams, operating within different wavelength ranges (and generated from a single wavelength input), each wavelength range associated with performing certain manufacturing/industrial processes on different materials (typically, metals or alloys).

In accordance with the principles of the present invention, an exemplary high power, dual wavelength laser source is formed of a plurality of conventional IR laser diodes disposed in an aligned configuration such that the output beams from the plurality of laser diodes are simultaneously passed through a bulk optic frequency multiplying device (e.g., a “frequency coupling” second harmonic generating (SHG) crystal a “frequency tripling” third harmonic generating (THG) crystal, or the like). The collection of laser diodes provides a high power input signal, where the power level itself is determined by the number of individual devices (or bars) used at the input. The frequency multiplying device creates a known harmonic of the input beam, providing as an output two beams, one operating at the original IR wavelength (denoted λ, typically within the range of 760-1100 nm for IR laser diodes) and another operating at a specific fraction of that original wavelength. The “specific fraction” created for the second output beam depends upon the multiplication factor of the bulk optic device, where the use of a SHG crystal provides a second output at the wavelength λ/2. Depending on the initial wavelength of the input IR signal, this second output at λ/2 will be within the visible wavelength range (typically a blue-green wavelength range from 380-550 nm). The use of a THG crystal provides a second output at a wavelength of λ/3 (where this second output may be in the UV wavelength range). For the purposes of the present invention, the conversion efficiency of the input IR wave to the visible laser output does not have to be relatively high (i.e., conversion efficiency of less than about 40% is sufficient), inasmuch as it is preferred to retain a sufficient power level at the original IR wavelength to provide the “dual wavelength” output. Various properties of the bulk optic crystal itself (including its ambient operating temperature) may be adjusted to control the resultant conversion efficiency (and, related, the output power provided in each of the two separate output beams).

The number of individual IR laser diodes/emitter regions used as the input to the frequency multiplying device is selected to generate an output power suitable for a particular cutting/welding operation, where configurations using tens of individual devices have been found to provide power of several tens watts for the output beam operating at the visible wavelength, while able to retain power for the output beam operating at the original IR wavelength on the order of several hundreds of watts, perhaps even greater than 1 kW. Embodiments of the present invention may utilize individual, discrete laser diode elements, or integrated laser diode configurations having a plurality of separate emitter regions fabricated within a semiconductor substrate and disposed as a one-dimensional array (commonly referred to as a “laser diode bar”). The laser diodes may be either single mode or multimode (with the associated optics configured accordingly). Additionally, the laser diodes may be selected to all operate at the same wavelength, or operate at different wavelengths within the IR band. The use of multiple wavelengths (and, therefore, the generation of multiple ‘frequency doubled’ outputs) allows for a relatively high power visible laser source to be formed from a relatively small number of individual laser diodes.

The laser diode devices (or bars) may be stacked in either a “fast axis” direction or “slow axis” direction, with appropriate focusing elements used to direct the collection of free-space beams into a relatively small, homogeneous spot size at the input of the frequency doubling element. Optimum frequency doubling is provided when the BPP is relatively small and controlled. In particular, the number of individual devices N used to form a stack may be determined such that the accumulation of fast axis (FA) beam divergence matches the BPP in the slow axis (SA) direction.

The frequency multiplying element may comprise any suitable nonlinear optical element well known in the art to provide, for example second-harmonic or third-harmonic generation. Second harmonic generation is known to occur when two photons at the same frequency interact within a nonlinear material, “combine”, and output a new photon with twice the energy, and at twice the frequency (i.e., at half of the input wavelength of the two photons). Third harmonic generation occurs in a similar manner, creating a new photon at three times the original frequency. Various nonlinear bulk optic crystals such as, but not limited to lithium triborate (LiB₃O₅), β-barium borate (β-BaB₂O₄, or simply BBO), potassium dihydrogen phosphate (KDP), and periodically-poled lithium niobate (PPLN) are known to exhibit these harmonic generation effects. In designing a specific frequency multiplying configuration, factors such as crystal length, beam radius and divergence (i.e., BPP), walk-off, bandwidth, and temperature properties of the crystal material, as well as whether the specific application requires second harmonic or third harmonic generation, should be taken into account.

Certain embodiments of the present invention, particularly those that use a multi-wavelength IR source that extends across a large spectral range, may require the use of more than one frequency multiplying element, with the specific parameters of each frequency multiplying element designed to optimize harmonic generation performance within a specific wavelength region of the spectral range.

In several embodiments, the inventive laser source may be coupled to an end termination of an optical fiber cable or may be separately disposed within a process head of a laser-based material working tool. The frequency multiplying arrangement may be disposed in a fixed manner within a process head, or may be designed to be switched into and out of the output signal path as needed.

An exemplary embodiment of the present invention may take the form of a laser tool for material processing that comprises a plurality of input laser diode sources (typically operating within the IR wavelength range) arranged to combine their individual output emissions into a high power input beam. The laser tool also includes a frequency multiplying, harmonic generating bulk optic crystal element disposed to intercept the high power input beam. As the high power input beam propagates along the bulk optical crystal element, a portion of the propagating beam energy is converted into a harmonic beam operating at a wavelength that is a specific fraction of the input wavelength, providing as an output a pair of beams, a first output beam operating at the input wavelength and a second output beam operating at a fraction of the input wavelength.

Other and further embodiments and aspects of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 is a diagram illustrating the beam properties used to define the “beam-parameter product” (BPP);

FIG. 2 is a plot of absorption efficiency as a function of wavelength for various materials, particularly illustrating the low absorption efficiency of highly reflective materials at the IR wavelengths typically associated with laser-based cutting/welding tools;

FIG. 3 is a diagram of an exemplary dual wavelength laser tool formed in accordance with the present invention;

FIG. 4 illustrates an exemplary laser diode, showing the fast axis (FA) and low axis (SA) directions of its output beam;

FIG. 5 illustrates an alternative embodiment of the present invention, using a plurality of input laser diode sources operating at different IR wavelengths;

FIG. 6 shows another configuration of the alternative embodiment of FIG. 5, in this case using multiple SHG elements, each SHG designed for optimized operation within a given wavelength range;

FIG. 7 illustrates another embodiment of the present invention, in this case using a laser diode bar in place of discrete laser diode devices;

FIG. 8 shows an embodiment of the present invention that utilizes a plurality (i.e., a “stack”) of laser diode bars as the input IR beam source;

FIG. 9 illustrates a variation of the embodiment of FIG. 8, in this case using separate laser array stacks operating at different IR wavelengths;

FIG. 10 depicts a configuration of the present invention that includes a fiber cable for supplying the input IR beam, with the remaining components of the tool disposed at an opposing end termination of the fiber cable;

FIG. 11 depicts a configuration of the present invention that includes a delivery fiber disposed between the input IR beam and a process head including the frequency doubling element;

FIG. 12 illustrates an alternative arrangement of the configuration of FIG. 12, where in this case the frequency doubling component is “switchable” into and out of the optical signal path;

FIG. 13 shows the arrangement of FIG. 12, in this case with the frequency doubling component switched out of the signal path, so that the input IR beam is maintained and is presented as a single output beam; and

FIG. 14 illustrates yet another embodiment of the present invention, in this case incorporating a beam splitter within the input path to support a plurality of separate laser-based tools.

### DETAILED DESCRIPTION

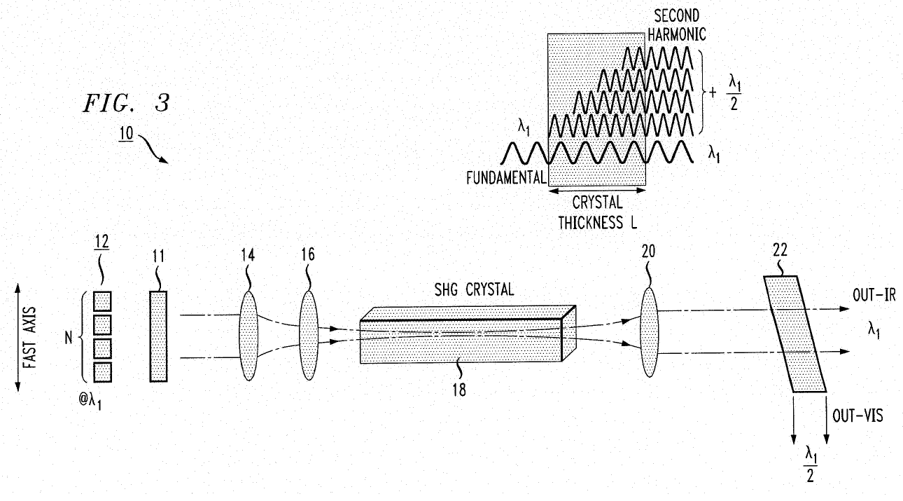

FIG. 3 illustrates an exemplary high power, dual wavelength laser source 10 formed in accordance with the principles of the present invention to provide in this particular configuration a first output beam at a visible wavelength (as preferred for initial working of highly reflective materials) and a second output beam at an IR wavelength typically used for laser material processing. In particular, laser light propagating within the visible wavelength range is known to have an absorption efficiency for highly reflective materials that is high enough to initialize processing of these highly reflective materials when at room temperature (“cold” material). An initial processing step for either cutting or welding relates to piercing through the outer skin of the material. At some point in time after this initial piercing, the material enters a molten phase (or a plasma is formed) and its absorption efficiency at both IR and visible wavelengths becomes essentially the same. Thus, by providing both wavelengths as its output, the inventive dual wavelength laser source is able to work on highly reflective materials and perform both the initial material piercing process and the following cutting/welding process using a single tool.

The use of a dual wavelength, two-beam output from the inventive laser source also allows for the tool to be used in situations where a composition being worked is formed of two different materials, each responding to a beam in a different wavelength range (in order to be welded, for example).

Referring to the particulars of FIG. 3, source 10 is based upon an input IR source that is formed of a plurality of individual semiconductor laser diodes 12, which may comprise conventional GaAs laser diodes that are known to operate at a wavelength in the IR range of 760-1100 nm, preferably 900-1060 nm (depending on fabrication parameters). In this particular embodiment, the plurality of individual laser diode devices are selected to all operate at the same IR wavelength Xi.

The individual laser diodes 12 are disposed so as to align their individual output beams, and this case stacked along the “fast axis” direction of the devices. A typical individual multimode laser diode 12 exhibits an emitter width on the order of 1-4 μm along the fast axis (FA) direction, with a slow axis (SA) emitter width on the order of about 100 μm, 200 μm or perhaps even more. FIG. 4 illustrates an exemplary laser diode 12, including its emitter region 13, with the fast axis and slow axis directions also shown. As shown, in the fast axis direction where emitter region 13 has a narrower dimension, the output beam exhibits a “faster” divergence; the beam along the width of emitter region 13 diverges much “slower” (the “slow axis”). Inasmuch as a preferred embodiment of the present invention exhibits a BPP that is the same along both the fast and slow axes, the number N of individual laser diodes 12 used to form the stack in the FA direction may be selected so that the accumulated BPP along the FA direction approaches the BPP associated with portion of the beam diverging along the SA direction.

In order to best function as a material processing tool (i.e., suitable for cutting or welding various metals), the inventive laser tool is required to provide not only two output beams at different wavelengths (e.g., IR and visible), but ensure that these beams have a sufficiently high power level to perform in an efficient manner. Indeed, it is preferred that the input IR light needs to be not only high power, but exhibit a relatively high level of intensity, with the combined input beam from the plurality of individual laser diodes 12 focused into a relatively small spot size. In order to form an essentially homogeneous beam of uniform intensity, it is necessary to provide focusing along both the FA and SA directions between the output of the laser diode stack and the input of the frequency multiplying element.

Referring back to FIG. 3, the output beams from the plurality of N individual laser diodes 12 is thereafter passed through a first (slow-axis) focusing lens 14 and a second (fast-axis) focusing lens 16 (perhaps in the other order) so as to focus both axes into a relatively small spot size, providing a relatively homogeneous beam at the input of a frequency multiplication element, in this particular example comprising a frequency doubling crystal 18. Also shown in FIG. 3 is a wavelength stabilization filter 11 (such as a Bragg grating) that is disposed between laser diodes 12 and first focusing lens 14. While optional in this particular configuration where all of the laser diodes 12 operate at the same IR wavelength, the use of a wavelength stabilization filter ensures that the input to frequency doubling crystal 18 remains essentially constant over time.

The functioning of frequency doubling crystal 18 is shown in the inset of FIG. 3, which illustrates the propagation of the input IR beam through the thickness L of crystal 18, as well as the accumulation of the second harmonic waves to form the frequency doubled output. As mentioned above, the photons within the input IR beam interact with the nonlinear material in a well-known manner, providing as an output a beam that includes a first portion operating at the same (input) IR wavelength and a second portion operating at twice the frequency (half the wavelength).

The use of a nonlinear optical element to provide this type of frequency multiplication is well-known in the art. Specific harmonic-generating materials that exhibit this effect include, as mentioned above, LBO, BBO, KDP, PPLN, and the like. The particulars of the specific bulk optical crystals are selected to provide, for example second-harmonic generation (SHG) or third-harmonic generation (THG), as best-suited for a particular application.

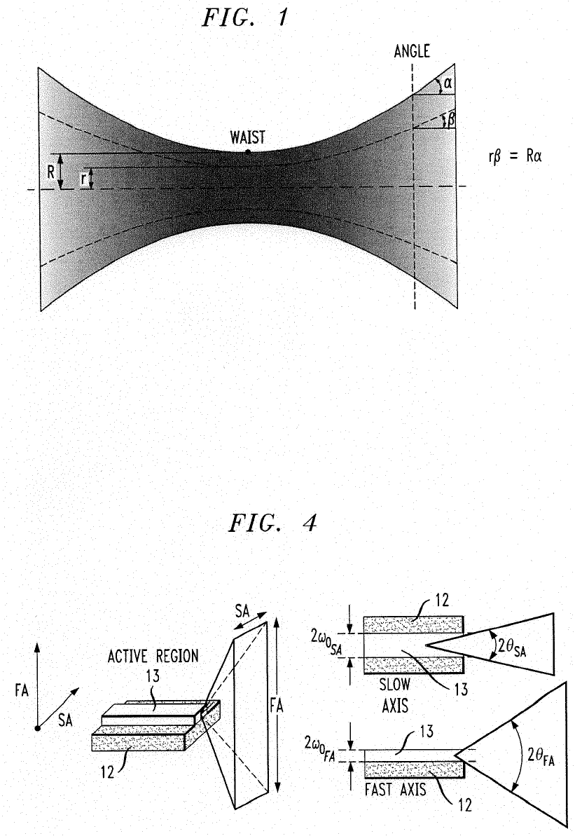

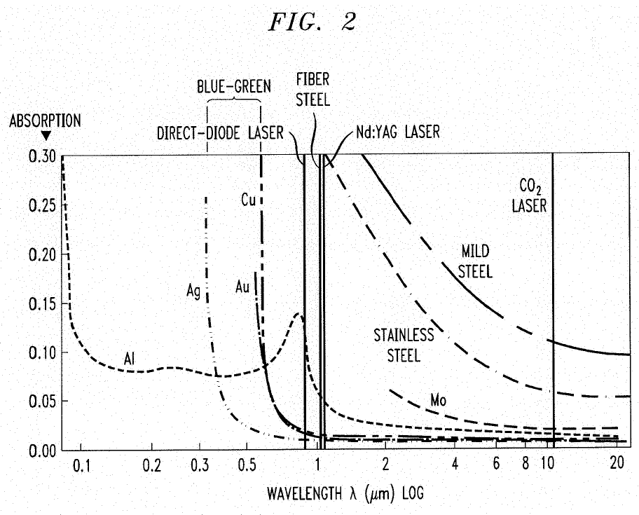

Again returning to the discussion of the specific embodiment of FIG. 3, the output from frequency doubling crystal 18 is thus two separate beams, a first beam OUT-IR propagating at the original wavelength λ₁, and a second beam OUT-VIS propagating at the frequency-doubled wavelength of (λ₁/2). For a GaAs laser diode operating at an IR wavelength in the 760-1100 nm range, the frequency-doubled visible wavelength beam OUT-VIS is within the range of about 380-550 nm, a visible beam within the “blue-green” range. An output lens 20 is shown in FIG. 1 as collimating the dual wavelength output.

For applications where it is desired to direct the IR wavelength portion of the output along a first signal path and the visible wavelength portion of the output along a second signal path, a dichroic filter 22 (or similar device) may be disposed in the output path beyond lens 20.

The visible light output derived in the manner shown in FIG. 3 may thereafter be used to perform initial procedures (such as piercing) on materials that have a relatively high absorption coefficient in this wavelength range (i.e., the “highly reflective” materials such as silver, copper, and gold, as described above). As mentioned above and will be discussed in detail below, the conversion efficiency between the input IR wave and the frequency-doubled output may be less than about 40%, which is acceptable since an optimum laser source of the present invention provides sufficient power in both output wavelengths, using the visible laser light to initiate the processing by piercing through the material and then using the IR light to perform the actual cutting/welding of the now-softened material. An exemplary embodiment of laser source 10 may provide a visible light output with a power of several tens of watts, and an IR light output with a power on the order of several hundreds of watts, perhaps even greater than 1 kW.

One way to increase the power level of both the IR and visible output beams is to use input laser diodes that operate at different IR wavelengths, with each wavelength being “frequency doubled” as it passes through the frequency doubled crystal 18.

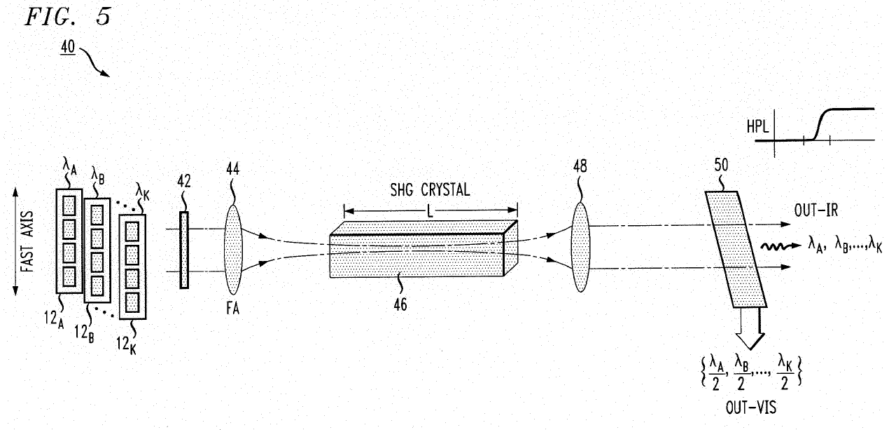

FIG. 5 illustrates one particular multi-wavelength visible/IR laser source 40, where a plurality of vertical stacks of individual laser diodes is utilized, each stack comprising a set of individual laser diode devices operating at a different IR wavelength. In particular, laser source 12 is illustrating a plurality of vertical stacks 12_{A}-12_{K}, where vertical stack 12_{A} comprises a plurality of laser diodes operating at a wavelength λ_{A}, stack 12_{B} comprises a plurality of laser diodes operating at a wavelength λ_{B}, and so on (with all wavelengths λ_{A} through λ_{K} being within the conventional IR region 760-1100 nm).

A volume Bragg grating (VBG) 42 (or similar type of filtering device) is disposed at the output of the multiple laser diode arrays 12, and functions to provide wavelength stability, each stack stabilized to remain centered on its associated output wavelength λ_{A} through λ_{K}, thus minimizing the spectral bandwidth of the system. The wavelength-stabilized beams are shown as then passing through an FA lens 44 to be focused into a frequency multiplying element, here a frequency doubling crystal 46 that functions to double the various set of frequencies passing through. In particular, the length L of frequency doubling crystal 46 is selected so that each incoming IR wavelength λ_{A} through λ_{K} will propagate a sufficient distance to create its associated frequency-doubled blue-green wavelength output. The beams exiting crystal 46 are then collimated by an output lens 48 to form the output beam of multi-wavelength laser source 40, including beams at the original IR wavelengths (λ_{A} through λ_{K} and denoted as “OUT-IR” in FIG. 5), as well as the frequency-doubled visible light output wavelengths λ_{A}/2 through λ_{K}/2 (shown as OUT-VIS in FIG. 5). It is to be understood that specific applications/materials that are being processed, a THG crystal may be preferable over a SHG crystal (for example, when a UV output is desired from an IR input).

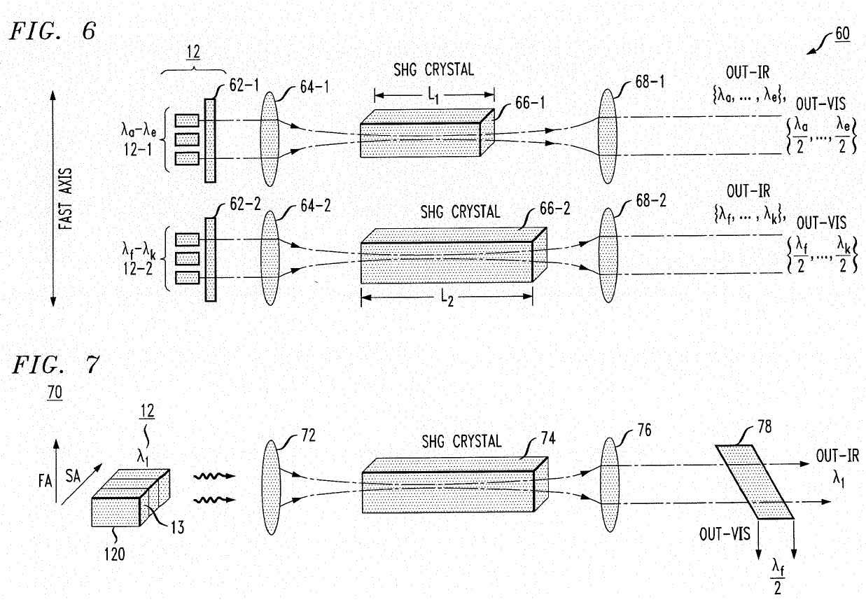

Depending on the spectral range of the multiple wavelengths in the configuration of FIG. 5, it may be preferred to use more than one element to provide accurate frequency multiplying across the entire wavelength range. Various properties of a given harmonic-generating crystal material are involved in providing frequency multiplication, where one important factor is the physical length of the device (higher wavelengths requiring a longer optical path in order to provide complete frequency multiplication at the output). FIG. 6 illustrates an embodiment of the present invention that addresses this concern by utilizing a pair of nonlinear elements to perform frequency doubling. As shown, a visible/IR laser source 60 includes a first laser source component 12-1 that operates over a first wavelength range λₐ-λₑ and a second laser source component 12-2 that operates over a second (shorter) wavelength range λ_{f}-λₖ.

Similar to the configuration of FIG. 5, a wavelength-stabilizing filter is associated with each multi-wavelength laser source, shown here in FIG. 6 as a first VBG 62-1 associated with first laser source component 12-1 and a second VBG 62-2 associated with a second laser source component 12-2. The wavelength-stabilized output beams from each set of laser diodes is subsequently passed through an associated FA focusing lens 64-1, 64-2, respectively. The focused (i.e., high intensity, homogeneous) beams are then introduced into separate frequency doubling crystals, shown here as a first SHG crystal 66-1, which is disposed to receive the focused output beams from laser source component 12-1, and a second SHG crystals 66-2, which is disposed to receive the focused output beams from laser source component 12-2. As mentioned above, each SHG (or THG) crystal is formed to have specific properties to best provide frequency doubling/tripling for the wavelengths provided as an input, where in the particular illustration of source 60 in FIG. 6, second frequency doubling crystal 66-2 is formed to be longer than first frequency doubling crystal 66-1 (for illustrative purposes only and not to scale) so as to efficiently double the frequency of the shorter-wavelength diodes forming second laser source component 12-2.

The embodiments described thus far are based upon the use of discrete laser diode elements as the initial source of IR light. Other configurations of laser source 12 of the present invention may utilize laser diode arrays, where several emitter regions are fabricated within a single “bar” of appropriate semiconductor material. FIG. 7 illustrates an exemplary visible/IR laser source 60 formed in accordance with the present invention that utilizes a laser diode bar 120 as the IR source. In this particular configuration, a plurality of emitter regions 13 is shown as formed within the bar, with laser diode bar 120 disposed such that emitter regions 13 extend along the slow axis direction of bar 120. In this example, laser diode 120 is fabricated such that each included laser diode operates at the same IR wavelength (for example, λ₁). A focusing lens 72 is disposed to direct the array of beams into a small spot size (as defined by the BPP) preferred for efficient frequency doubling within a following frequency doubling crystal 74. The two separate output beams, operating at the original IR wavelength λ₁ and the frequency-doubled blue light wavelength λ₁/2 exiting crystal 74 may then be passed through a collimating lens 76 to form the dual wavelength output.

As with the discrete laser diode embodiments described above, embodiments of the present invention based upon the use of laser diode bars may be configured to utilize stacks of bars, primarily to increase the output power generated by the laser source. FIG. 8 shows an exemplary visible/IR laser source 80 that is formed of a vertical stack along the “fast” axis direction of a plurality of N laser diode bars 120₁-120_{N}. Each bar may be configured to emit at the same IR wavelength, or each bar may be fabricated to emit at a different IR wavelength. In either case, a frequency doubling crystal 82 (also referred to as a “second harmonic generating” (SHG) crystal) functions in the same manner as discussed above to perform frequency doubling, forming a first output (OUT-IR) at the original input IR wavelength and a second output at the frequency-doubled visible wavelength (shown as OUT-VIS). Input focusing lenses 83, 85 may be included to control the FA and SA beam shaping of the combination of the emissions from the plurality of N laser diode bars, providing a more homogenous spot size at the input to SHG crystal 82. An output collimating lens 84 may be disposed beyond the output of SHG crystal 82 to control the divergence of the pair of output beams (OUT-IR and OUT-VIS). Again, it is to be understood that some specific embodiments may require the use of a THG crystal so as to create a second output at a wavelength that is one-third the value of the input wavelength (e.g., providing IR and UV output beams).

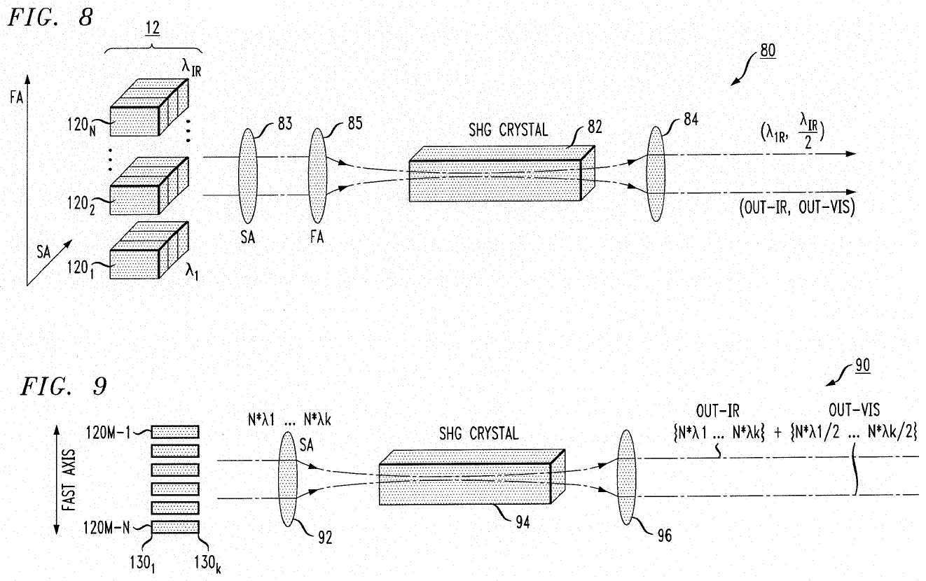

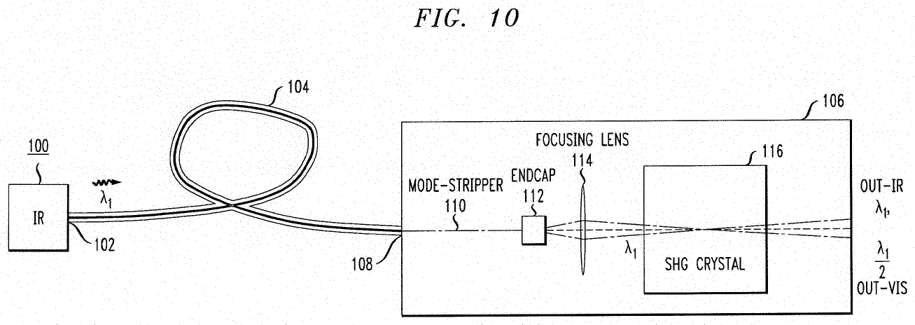

FIG. 9 illustrates yet another embodiment of the present invention, where a visible/IR laser source 90 is shown as using a plurality of multi-wavelength laser diode bars 120M. That is, each individual bar includes a plurality of emitters operating at different wavelengths 130₁ through 130ₖ, and bars 120M are formed as a stack of N components (stacked along the fast-axis direction, as shown in FIG. 9). Also included in the embodiment of FIG. 9 is an input beaming shaping lens 92, an SHG crystal 94, and an output collimating lens 96, where all elements function in the manner described above. Indeed, depending on the wavelength range associated with multi-wavelength bars 120M, the frequency doubling arrangement may utilize more than one SHG crystal (as discussed above in association with FIG. 6) to best provide frequency doubling over an extended wavelength range.

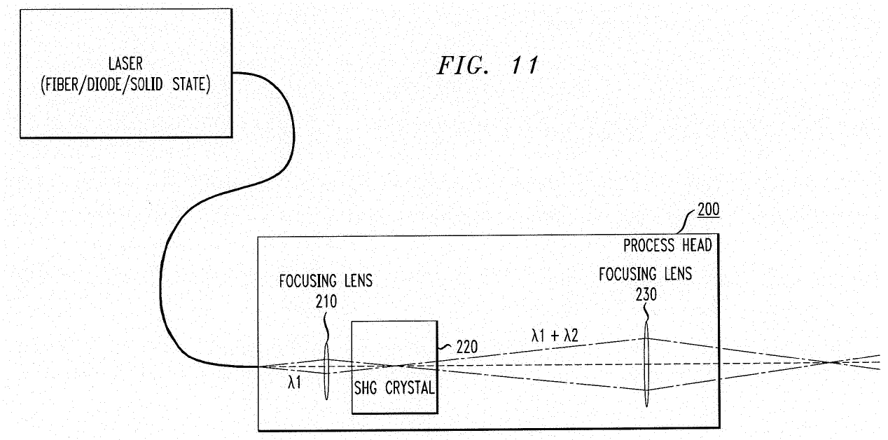

Regardless of the specific configuration of components, a visible/IR laser source formed in accordance with the present invention may utilize an input light source that is formed along an end termination of an optical fiber cable. This is illustrated in FIG. 10, which shows an input IR-wavelength light source 100 disposed at a first end location 102 of an optical fiber cable 104, and the remaining components of the visible/IR laser source disposed within a housing 106 that is coupled to a second, opposing endpoint 108 of cable 104. In this particular embodiment, a portion of cable 104 is stripped to expose an interior bare fiber 110 that is coupled to a termination element 112. The propagating IR beam thereafter exits termination element 112 and propagates through free space. A lens 114 may be included and used to direct the free space beam into an included SHG crystal 116 (i.e., a frequency-doubling element as discussed above). In this particular embodiment, lens 114 may comprise a collimating lens (instead of a focusing elements), where a collimated version of the propagating free space beam is considered to have a sufficient intensity to create a useful visible light output. It is to be understood that a focusing lens may also be used, particular in situations where a higher intensity is required. The output from housing 106 is thus both the original IR beam and the visible light beam formed by operation of SHG crystal 116. Moreover, instead of using a separate lens element, an endcap of the housing may be formed (i.e., curved) to provide a sufficient amount of optical focusing.

Instead of directly performing the frequency multiplying within the cable, other embodiments of the present invention are contemplated as using an IR source disposed at a first location and the remaining components disposed in a device such as a “cutting head” that is used to perform the cutting/welding processes. FIG. 11 illustrates one configuration of this particular embodiment. In particular, FIG. 11 illustrates a process head 200 that is formed to including an input focusing lens 210, an SHG crystal 220 (or a suitable THG crystal, as the case may be), and an output focusing lens 230. An IR input signal (from a laser source, not shown), is delivered to process head 200 via an optical fiber 240, and is aligned so that the output IR beam from fiber 240 passes through input focusing lens 210 and enters nonlinear element 220. A beam operating at the original IR wavelength, as well as a frequency-doubled, visible beam (operating at a blue-green wavelength) exit SHG crystal 220 and pass through focusing lens 230 before exiting process head 200.

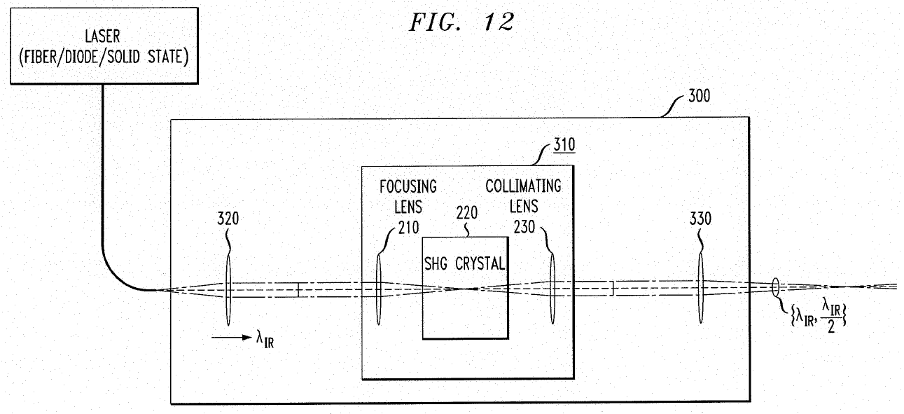

FIG. 12 illustrates another embodiment of a process head 300, where in this case the components performing the frequency doubling (i.e., input lens 210, nonlinear element 220, and output lens 230) are configured as a single “frequency doubling” component 310 that may be switched into and out of the signal path along process head 300. That is, as shown in FIG. 12, an incoming IR signal (perhaps entering along optical fiber 240) first passes through an input collimating lens 320 and is thereafter directed into frequency doubling component (i.e., an SHG crystal) 310. The output beams from component 310 (i.e., original IR beam, and frequency-doubled visible beam) subsequently pass through an output focusing lens 330, providing both the initial “piercing” beam of blue-green light and the follow-on cutting/welding beam of IR light.

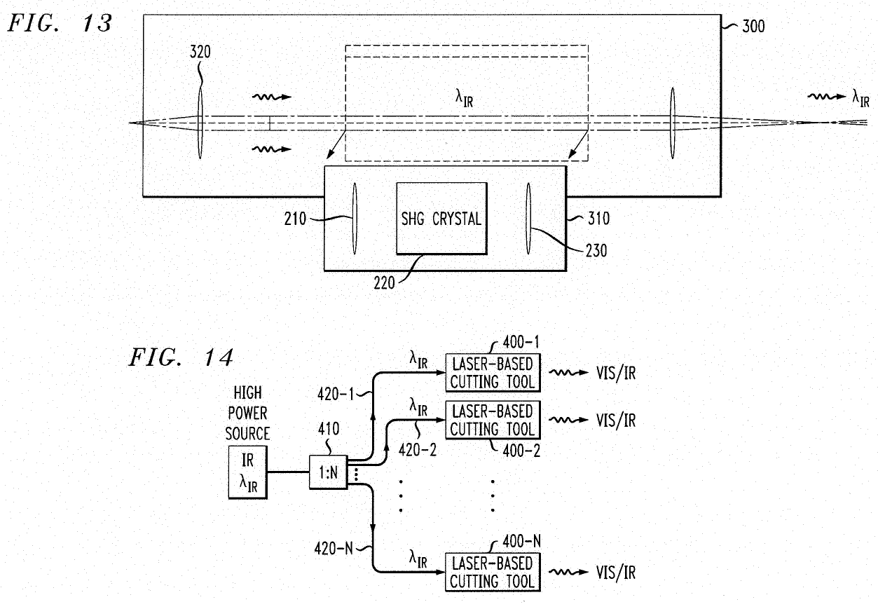

In accordance with this embodiment of the present invention, component 310 may be switched out of the signal path (through various mechanical and/or optical means), so that the incoming IR beam is not frequency doubled, and passes directly through both input focusing lens 320 and output focusing lens 330. FIG. 13 illustrates this “state” of process head 300. In this case, only the IR beam is provided as the output of process head 300. As mentioned above, once the initial “piercing” of the material has been performed by the visible beam, the remainder of the cutting/welding proceeds more efficiently if only the IR beam is present. Thus, including the ability to switch the frequency doubling capability into and out of the signal path within the process head is a significant advantage of this particular embodiment of the present invention.

FIG. 14 illustrates yet another embodiment of the present invention, where a single high power IR light source is used as an input for multiple laser-based cutting tools 400-1 through 400-N. As shown, the high power IR light beam first passes through a 1:N splitter 410, which divides the input high power into a plurality of N output IR beams, shown here as propagating along a plurality of fibers 420-1 through 420-N. Each tool 400 includes its own frequency doubling component, operating in the same manner as described above.

Summarizing, the present invention is directed to providing frequency doubling of diode lasers (multi-mode as well as single-mode), using either direct laser diode devices or arrays of emitter regions in bar form, in order to perform material processes such as cutting or welding. The use of a plurality of frequency-doubled laser diodes offset excellent beam quality, while also providing as an output not only the frequency-doubled visible laser beam, but the original beam as well.

While the various embodiments as described above were directed to the utilization of the apparatus of the present invention to provide a “visible” (i.e., blue-green wavelength range) output beam from an input IR wavelength beam, an alternative configurations of this apparatus can just as well convert a portion of a laser beam operating at any first wavelength into a second wavelength of one-half the first wavelength value. For example, a “visible” range input laser beam may be used to form a dual-wavelength output of both a visible wavelength beam and an ultra-violet (UV) wavelength output beam. Further, specific embodiments may utilize a third-harmonic generation (THG) crystal as a frequency multiplying element (instead of an SHG crystal) in order to provide two output beams at desired wavelengths.

Indeed, the foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A laser tool for material processing, comprising:
a plurality of input laser diode sources operating within a first wavelength range and arranged to combine a plurality of beams into a high power input beam; and
a frequency multiplying bulk optic crystal element disposed to intercept the high power input beam, wherein as the high power input beam propagates along the frequency multiplying bulk optical crystal element, a portion of the beam energy is converted into a harmonic beam operating at a second wavelength that is a fraction of the first wavelength as defined by a frequency multiplying factor, providing as an output a pair of beams, a first output beam operating within the first wavelength range and a second output beam operating at the defined fraction of the first wavelength.

2. The laser tool as defined in claim 1 wherein the tool further comprises a wavelength division demultiplexer disposed beyond the output of the frequency multiplying bulk optic crystal element and used for directing the first output beam along a first output signal path and the second output beam along a second output signal path.

3. The laser tool as defined in claim 1 wherein the plurality of input laser diode sources is aligned in a slow axis direction.

4. The laser tool as defined in claim 1 wherein the plurality of input laser diode sources is aligned in a fast axis direction.

5. The laser tool as defined in claim 1 wherein the tool further comprises an input lensing arrangement disposed between the plurality of input laser diode sources and the frequency multiplying bulk optic crystal element, the input lensing arrangement for focusing the plurality of outputs from the laser diode sources into the high power input beam at the input of the frequency multiplying bulk optic crystal element.

6. The laser tool as defined in claim 1 wherein a number of individual laser diode sources forming the plurality of laser diode sources is selected such that a combined fast axis beam width substantially matches a slow axis beam width, providing a homogenous high power input beam.

7. The laser tool as defined in claim 1 wherein the plurality of laser diode sources comprises a plurality of discrete laser diode devices.

8. The laser tool as defined in claim 1 wherein the plurality of laser diode sources comprises at least one laser diode bar, comprising a plurality of individual emitter regions formed along an axis of the bar.

9. The laser tool as defined in claim 1 wherein the plurality of laser diode sources comprises a two-dimensional array of laser diode sources.

10. The laser tool as defined in claim 1 wherein the plurality of laser diode sources operate at substantially the same wavelength.

11. The laser tool as defined in claim 1 wherein the plurality of laser diode sources operate at different wavelengths within the first wavelength range, the laser tool further comprising a wavelength stability filter disposed between the plurality of laser diode sources and the frequency multiplying bulk optic crystal element.

12. The laser tool as defined in claim 1 wherein the frequency multiplying bulk optic crystal element comprises a second-harmonic generating (SHG) bulk optic crystal element.

13. The laser tool as defined in claim 1 wherein the frequency multiplying bulk optic crystal element comprises a third-harmonic generating (THG) bulk optical crystal element.

14. The laser tool as defined in claim 1 wherein the input wavelength range is about 780-1100 nm, defining an IR input wavelength.

15. The laser tool as defined in claim 14, where the frequency multiplying bulk optic crystal element comprises a second-harmonic generating (SHG) bulk optical crystal element, providing a second output in a visible wavelength range of 380-550 nm.

16. The laser tool as defined in claim 1 wherein the tool further comprises
an optical fiber cable disposed between the plurality of laser diode sources and the frequency multiplying bulk optic crystal element, the optical fiber cable including a delivery fiber supporting the propagation of the input beam to the frequency multiplying bulk optic crystal element.

17. The laser tool as defined in claim 1 wherein the frequency multiplying bulk optic crystal element is configured to be switched into and out of the signal path.

18. The laser tool as defined in claim 1 wherein the frequency multiplying bulk optic crystal element is selected from the group consisting of: nonlinear bulk optic crystals such as, but not limited to lithium triborate (LiB₃O₅), β-barium borate (β-BaB₂O₄, or simply BBO), potassium dihydrogen phosphate (KDP), and periodically-poled lithium niobate (PPLN).

19. A laser-based cutting tool for use with highly reflective materials the tool comprising
a plurality of input laser diode sources operating within a first wavelength range and arranged to combine a plurality of beams into a high power input beam;
an optical fiber cable coupled to the output of the plurality of laser diode sources for supporting the propagation of the high power input beam;
a 1:N optical splitter coupled to the optical fiber cable;
a plurality of N delivery fibers exiting the 1:N optical splitter, each delivery fiber supporting a reduced-power beam; and
a plurality of frequently multiplying bulk optic crystal elements coupled to a separate one of the plurality of N delivery fibers, wherein as the high power input beam propagates along each frequency multiplying bulk optical crystal element, a portion of the beam energy is converted into a harmonic beam operating at a visible wavelength that is a known fraction of the first wavelength, providing as an output a pair of beams, a first output beam operating at the first wavelength of the input beam and a second output beam operating at the known fraction thereof.

20. A laser tool for material processing, comprising:
a plurality of laser diode sources operating at a first wavelength with a selected input wavelength range, the plurality of laser diode sources arranged to combine a plurality of beams into a high power input beam; and
a second harmonic generating (SHG) bulk optic crystal element disposed to intercept the high power input beam, wherein as the high power input beam propagates along the SHG bulk optical crystal element and a portion of the beam energy is converted into a second harmonic beam operating a second wavelength that is one-half of the first wavelength, providing as an output a pair of beams including a first output beam operating at the first wavelength and a second output beam operating at the second wavelength.
